(19) United States
(12) Patent Application Publication
(10) Pub. No.: US 2025/0018469 A1
(43) Pub. Date: Jan. 16, 2025

(54) PREALLOY POWDER FOR POWDER METALLURGY, A SINTERED PART USING THE SAME, AND A MANUFACTURING METHOD THEREOF

(71) Applicants: HYUNDAI MOTOR COMPANY, Seoul (KR); KIA CORPORATION, Seoul (KR); KOREA SINTERED METAL CO., LTD., Daegu (KR)

(72) Inventors: Hak Soo Kim, Seoul (KR); Go Woon Jung, Hwaseong-si (KR); Jin Hyeon Lee, Seongnam-si (KR); Jung Hyuk Kim, Daegu (KR); Joo Sung Park, Daegu (KR); Dong Kuk Jeong, Daegu (KR)

(73) Assignees: HYUNDAI MOTOR COMPANY, Seoul (KR); KIA CORPORATION, Seoul (KR); KOREA SINTERED METAL CO., LTD., Daegu (KR)

(21) Appl. No.: 18/497,784

(22) Filed: Oct. 30, 2023

(30) Foreign Application Priority Data
Jul. 10, 2023 (KR) 10-2023-0089322

(51) Int. Cl. B22F 3/24; B22F 3/16; B22F 9/08; C22C 38/22

(52) U.S. Cl. CPC B22F 3/24; B22F 3/16; B22F 9/082; C22C 38/22; B22F 2003/241; B22F 2009/0828; B22F 2201/013; B22F 2201/02; B22F 2202/13; B22F 2301/35; B22F 2998/10; B22F 2999/00

(57) ABSTRACT

A prealloy powder for powder metallurgy, a sintered part using the same, and a manufacturing method thereof, which is configured to prevent deterioration of core hardness along with surface hardening while maintaining excellent tensile strength by adjusting an alloy composition so that a bainite phase is formed. The sintered part, which is manufactured by powder metallurgy, includes 1.05 to 1.55 wt % of Cr, 0.3 to 0.5 wt % of Mo, 0.5 to 0.7 wt % of C, and a remaining of Fe and other unavoidable impurities.

### CROSS-REFERENCE TO RELATED APPLICATION

The present application claims priority to and the benefit of Korean Patent Application No. 10-2023-0089322 filed on Jul. 10, 2023, the entire contents of which are incorporated herein for all purposes by this reference.

### BACKGROUND OF THE DISCLOSURE

### Field of the Disclosure

The present disclosure relates to a prealloy powder for powder metallurgy, a sintered part using the same, and a manufacturing method thereof. More particularly, the present disclosure relates to a prealloy powder for powder metallurgy, a sintered part using the same, and a manufacturing method thereof, which is configured to prevent deterioration of core hardness along with surface hardening while maintaining excellent tensile strength by adjusting an alloy composition so that a bainite phase is formed.

### Description of the Related Art

When a structural sintered part for an engine, transmission, etc. is required to have wear-resistant properties, an ion nitriding treatment is performed to modify a surface of the sintered part.

However, since a diffusion layer to support a compound layer is reduced when a conventional sintered material is ion nitrided, it is not suitable for use in parts that require high load wear resistance, and there is an insignificant effect of improving fatigue properties.

Meanwhile, there is a problem in that the sintered material, unlike a steel material, had a low diffusion layer hardness due to a weak nitride formation in a matrix structure during ion nitriding.

In more detail, the sintered material has fewer elements that are easy to form nitrides such as Cr (chromium), Al (aluminum), Ti (titanium), and V (vanadium) during ion nitriding, and is mainly composed of a pearlite structure due to high carbon content, which causes the diffusion of nitrogen to be hindered.

Further, in recent years, a sintered material containing Cr has been developed, but there has been a disadvantage in that the sintered material does not have surface hardness and diffusion depth comparable to those of the steel material.

Therefore, research has been conducted on an alloy composition with a microstructure suitable for ion nitriding based on the fact that there is an effect on nitrogen diffusion during ion nitriding depending on the microstructure of the sintered material.

The foregoing explained as the background is intended merely to aid in the understanding of the background of the present disclosure, and is not intended to mean that the present disclosure falls within the purview of the related art that is already known to those skilled in the art.

### SUMMARY OF THE DISCLOSURE

Accordingly, the present disclosure has been made keeping in mind the above problems occurring in the related art, and the present disclosure is intended to provide a prealloy powder for powder metallurgy, a sintered part using the same, and a manufacturing method thereof, which is configured to prevent deterioration of core hardness along with surface hardening while maintaining excellent tensile strength by adjusting an alloy composition so that a bainite phase is formed.

Technical problems to be solved by the present disclosure are not limited to the above-mentioned technical problems, and other technical problems, which are not mentioned above, may be clearly understood from the following descriptions by those skilled in the art to which the present disclosure pertains.

The prealloy powder for powder metallurgy according to one embodiment of the present disclosure is a prealloy powder for powder metallurgy used for the manufacturing of the sintered part. The prealloy powder may include 1.05 to 1.55 wt % of Cr (chromium), 0.3 to 0.5 wt % of Mo (molybdenum), a remaining of Fe (iron) and other unavoidable impurities.

The content of Cr and Mo in the prealloy powder may satisfy Relational Equation 1 below:

$$0.1 \times [ Cr ] + 9.7 \times [ Mo ] > 3 \qquad [ Relational Equation 1 ]$$

In Relational Equation 1, [Cr] refers to a content of Cr (wt %) and [Mo] refers to a content of Mo (wt %).

The impurities may include Si (silicon), Mn (manganese), P (phosphorus), S (sulfur), Ni (nickel), Cu (copper), or combinations thereof, and satisfy Relational Equation 2 below:

$$[ Si ] + [ Mn ] + [ P ] + [ S ] + [ Ni ] + [ Cu ] < 0.5 \qquad [ Relational Equation 2 ]$$

In Relational Equation 2, [Si], [Mn], [P], [S], [Ni], and [Cu] refers to a content (wt %) of Si, Mn, P, S, Ni, and Cu, respectively.

Meanwhile, a sintered part, according to an embodiment of the present disclosure, which is manufactured by powder metallurgy, may include 1.05 to 1.55 wt % of Cr, 0.3 to 0.5 wt % of Mo, 0.5 to 0.7 wt % of C (carbon), and a remaining of Fe and other unavoidable impurities.

A matrix structure of the sintered part may be a bainite phase.

The sintered part may have a microstructure further formed by the impurities, and an area of the microstructure may be 0.6% or less per 200 mm².

A density of the sintered part may be in a range of 6.8 to 7.2 g/cm³.

A surface hardness of the sintered part may be Hv 500 or more, and a diffusion depth of nitrogen may be 0.2 mm or more from a surface of the sintered part.

A core hardness of the sintered part may be HRB 75 or more.

A tensile strength of the sintered part may be 430 MPa or more.

Meanwhile, a method of manufacturing a sintered part, according to an embodiment, is a method of manufacturing a sintered part by powder metallurgy. The method may include: a prealloy powder preparation act of preparing a prealloy powder including 1.05 to 1.55 wt % of Cr, 0.3 to 0.5 wt % of Mo, and a remaining of Fe and other unavoidable impurities; a mixed powder preparation act of preparing a mixed powder by mixing the prepared prealloy powder with a carbon powder and a lubricant; a forming act of forming the prepared mixed powder to prepare a formed body; a sintering act of sintering the prepared formed body; a post-processing act of post-processing a sintered part of the formed body sintered; and an ion nitriding act of ion nitriding the post-processed sintered part.

The prealloy powder preparation act may include: a molten metal preparation process of preparing a molten metal including 1.05 to 1.55 wt % of Cr, 0.3 to 0.5 wt % of Mo, and a remaining of Fe and other unavoidable impurities; and a water spraying process of preparing a prealloy powder by water spraying the prepared molten metal.

In the mixed powder preparation act, 0.5 to 0.7 wt % of the carbon powder, 0.5 to 0.7 wt % of the lubricant, and the remaining of the prealloy powder may be mixed.

In the mixed powder preparation act, a functional additive in a range of 0.1 to 0.2 wt % may be further mixed.

In the forming act, a formation density of the formed body may be in a range of 6.8 to 7.2 g/cm³.

The sintered part sintered in the sintering act may have a bainite phase formed.

The sintering act may be carried out in a mixed gas atmosphere of nitrogen and hydrogen at a temperature in a range of 1100 to 1150° C. for 20 to 40 minutes.

The sintered part treated in the ion nitriding act may maintain a bainite phase.

The sintered part treated in the ion nitriding act may have a compound layer formed 7 μm or more from a surface of the sintered part.

The ion nitriding act may be carried out in a nitrogen gas atmosphere at a temperature in a range of 500 to 600° C. for 3 to 5 hours.

According to an embodiment of the present disclosure, by adjusting a composition of the prealloy powder so that a bainite phase is formed, nitrogen diffusion during ion nitriding is facilitated so that the excellent surface hardness and diffusion depth are maintained, and accordingly, it is expected to improve fatigue properties in addition to wear resistance properties.

In addition, by subjecting the sintered part to ion nitriding treatment, it is possible to expect an effect that not only improves surface hardness but also inhibits degradation of core properties, thereby maintaining excellent tensile strength and preventing deterioration of core hardness. Accordingly, it is possible to manufacture component materials favorable for machining processes such as drilling.

### BRIEF DESCRIPTION OF THE DRAWINGS

FIGS. 1A to 1E are photographs showing microstructures before and after ion nitriding treatment of sintered parts according to Comparative Examples and Examples.

FIG. 2 is a graph illustrating results of measuring surface portion hardness after ion nitriding treatment of sintered parts according to Comparative Examples and Examples.

The drawings described herein are for illustration purposes only and are not intended to limit the scope of the present disclosure in any way.

### DETAILED DESCRIPTION OF THE DISCLOSURE

Hereinafter, embodiments disclosed in the present specification are described in detail with reference to the accompanying drawings. The same or similar constituent elements are assigned with the same reference numerals regardless of reference numerals, and the repetitive description thereof is omitted.

The suffixes ‘module,’ ‘unit,’ ‘part,’ and ‘portion’ used to describe constituent elements in the following description are used together or interchangeably in order to facilitate the description, but the suffixes themselves do not have distinguishable meanings or functions.

In the description of the exemplary embodiments disclosed in the present specification, the specific descriptions of publicly known related technologies is omitted when it is determined that the specific descriptions may obscure the subject matter of the exemplary embodiments disclosed in the present specification. In addition, it should be interpreted that the accompanying drawings are provided only to allow those skilled in the art to easily understand the exemplary embodiments disclosed in the present specification, and the technical spirit disclosed in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having,” or other variations thereof are inclusive and therefore specify the presence of stated features, integers, acts, operations, elements, components, or combinations thereof, but do not preclude the presence or addition of one or more other features, integers, acts, operations, elements, components, or combinations thereof.

A prealloy powder for powder metallurgy according to one embodiment of the present disclosure is an alloy powder used to manufacture a structural sintered part by a powder metallurgy method, in which the type and content of an alloy component are adjusted to form a bainite phase after sintering and after ion evolution treatment.

Further, the sintered part manufactured using the prealloy powder may be manufactured using a mixed powder in which the prealloy powder is mixed with a carbon powder and a lubricant. In this case, a functional additive may be further mixed into the mixed powder. However, the lubricant is vaporized during the sintering of the sintered part and does not remain in a final sintered part.

For example, the prealloy powder for powder metallurgy includes 1.05 to 1.55 wt % of Cr, 0.3 to 0.5 wt % of Mo, and a remaining of Fe and other unavoidable impurities.

Further, the sintered part includes 1.05 to 1.55 wt % of Cr, 0.3 to 0.5 wt % of Mo, 0.5 to 0.7 wt % of C, and a remaining of Fe and other unavoidable impurities.

Further, the sintered part may further include the functional additive in a range of 0.1 to 0.2 wt %. In this case, various functional additives may be applied to secure the physical properties, formability, and processability of the sintered part.

Meanwhile, Cr and Mo, which are main alloy elements in the prealloy powder that forms the sintered material, are components that are included to secure rigidity in structural parts and are alloy elements that stabilize a bainite phase, which is a microstructure of the prealloy powder.

Therefore, when Cr and Mo are contained in less than a suggested content range, the bainite phase, which is a microstructure, is not stably formed and the strength of the sintered part may not be secured at a desired level. Further, when Cr and Mo are contained in more than the suggested content range, the formability is degraded or the cost of the sintered part increases.

In particular, Cr inhibits the formation of the bainite phase and leads to the formation of a martensite phase when Cr is contained in more than the suggested content range.

In addition, C is a material that is prepared as a carbon powder separately from the prealloy powder and mixed with the prealloy powder, and is an additive element that stabilizes the bainite phase along with Cr and Mo.

Therefore, even when C is contained in less than the suggested content range, a ferrite phase, which is a microstructure, is formed and the bainite phase is not stably formed, and when C is contained in more than the suggested content range, a pearlite phase is formed, and the formability is degraded.

In one embodiment, the prealloy powder may have a content of Cr and Mo that satisfies Relational Equation 1 below:

$$0.1 \times [ Cr ] + 9.7 \times [ Mo ] > 3 \qquad [ Relational Equation 1 ]$$

In this case, in Relational Equation 1, [Cr] refers to the content of Cr (wt %) and [Mo] refers to the content of Mo (wt %).

When the content of carbon (C) powder is in a range of 0.5 to 0.7 wt % but does not satisfy the condition of Relational Equation 1 in case of manufacturing the sintered part, a sorbite phase is formed along with the bainite phase, resulting in a problem of low hardness.

Further, the prealloy powder according to one embodiment of the present disclosure may include Si, Mn, P, S, Ni, Cu, or combinations thereof as impurities. In certain examples, the impurities satisfy Relational Equation 2 below:

$$[ Si ] + [ Mn ] + [ P ] + [ S ] + [ Ni ] + [ Cu ] < 0.5 \qquad [ Relational Equation 2 ]$$

In Relational Equation 2 above, [Si], [Mn], [P], [S], [Ni], or [Cu] refer to the content (wt %) of Si, Mn, P, S, Ni, or Cu, respectively.

By adjusting the content of impurities as described above, it is possible to minimize an area where a microstructure unavoidably formed by impurities is formed while providing that the bainite phase is sufficiently formed as the matrix structure of the sintered part.

In one embodiment, the area of microstructure unavoidably formed by impurities is limited to 0.6% or less per 200 mm².

Therefore, by adjusting the composition and content of the prealloy powder and the sintered part as described above, the sintered part can maintain a surface hardness of Hv 500 or more, a core hardness of HRB 75 or more, and a tensile strength of 430 MPa or more.

Further, the sintered part may have a density in a range of 6.8 to 7.2 g/cm³, and that a diffusion depth of nitrogen by ion nitriding treatment is 0.2 mm or more from a surface thereof.

Next, a method of manufacturing the sintered part described above is described.

A method of manufacturing the sintered part according to one embodiment of the present disclosure includes a prealloy powder preparation act of preparing a prealloy powder; a mixed powder preparation act of preparing a mixed powder by mixing a carbon powder and a lubricant in the prepared prealloy powder; a forming act of forming the prepared mixed powder to prepare a formed body; a sintering act of sintering the prepared formed body; a post-processing act of post-processing a sintered part of the formed body sintered; and an ion nitriding act of ion nitriding the post-processed sintered part.

The prealloy powder preparation act includes preparing an iron-based prealloy powder to constitute the sintered part.

In this case, the prealloy powder may include 1.05 to 1.55 wt % of Cr, 0.3 to 0.5 wt % of Mo, and a remaining of Fe and other unavoidable impurities.

Further, the prealloy powder may include Si, Mn, P, S, Ni, Cu, or combinations thereof as impurities, and a total content of the impurities may be 0.5 wt % or less.

Meanwhile, the prealloy powder preparation act may be performed by dividing the prealloy powder preparation act into a molten metal preparation process of preparing a molten metal containing 1.05 to 1.55 wt % of Cr, 0.3 to 0.5 wt % of Mo, and a remaining of Fe and other unavoidable impurities; and a water spraying process of preparing a prealloy powder by water spraying the prepared molten metal.

The mixed powder preparation act includes preparing a mixed powder by mixing a carbon powder and a lubricant in the prealloy powder to form a sintered part. Further, a functional additive may be mixed as needed.

In this case, carbon powder and lubricant is adjusted in content and mixed with the prealloy powder so that the mixed powder includes 1.05 to 1.55 wt % of Cr, 0.3 to 0.5 wt % of Mo, 0.5 to 0.7 wt % of C, 0.5 to 0.7 wt % of a lubricant, and a remaining of Fe and other unavoidable impurities. Further, a functional additive is adjusted in content and mixed as needed. For example, the functional additive may be mixed at a level in a range of 0.1 to 0.2 wt %.

The forming act includes producing a formed body by forming the prepared mixed powder. For example, the formed body is produced by press-forming the mixed powder into a desired form.

In this case, the formed body may have a formation density in a range of 6.8 to 7.2 g/cm³.

When the formation density of the formed body is less than 6.8 g/cm³, the strength of the sintered part may be decreased. Further, when the formation density is greater than 7.2 g/cm³, a mold may be broken during press forming.

The sintering act includes sintering the formed body with a predetermined shape.

The formed body is sintered in a mixed gas atmosphere of nitrogen and hydrogen. In this case, a mixing ratio of nitrogen to hydrogen may be maintained in the range of 80-90 wt % nitrogen: 10-20 wt % hydrogen.

Further, the formed body may be maintained at a temperature in a range of 1100 to 1150° C. for 20 to 40 minutes and then cooled under an air cooling condition.

In this case, the sintered part that is sintered in the sintering act forms a bainite phase.

The post-processing act includes performing various post-processing treatments such as drilling, turning, etc. on the sintered part that is sintered to correspond to a final shape of the sintered part.

The ion nitriding act includes ion nitriding the sintered part that have been post-processed.

An atmosphere in which the sintered part is ion nitrided may be maintained at a temperature in a range of 500 to 600° C. in a nitrogen gas atmosphere for 3 to 5 hours and then cooled under an air cooling condition.

In this case, the sintered part that has been subjected to ion nitriding treatment maintains a bainite phase.

Meanwhile, the sintered part treated in the ion nitriding act has a compound layer including a nitrogen compound formed more than 7 μm from the surface thereof.

Next, the present disclosure is described with reference to Comparative Examples and Examples.

First, in the Comparative Examples and Examples, the formed body was prepared by changing the content of the ingredients as shown in Table 1 below, and then the sintering act and ion nitriding act were performed. In this case, in all the Comparative Examples and Examples, 0.15 wt % of processability additive and 0.6 wt % of lubricant as functional additives were mixed.

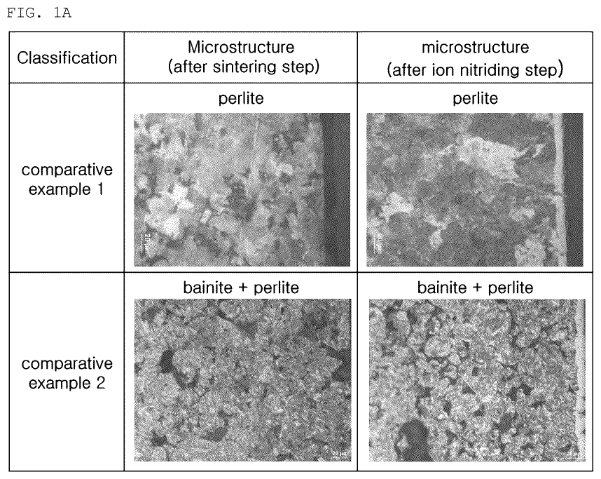

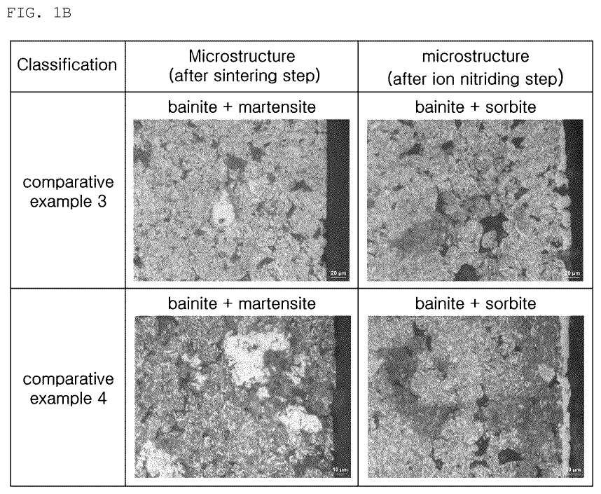

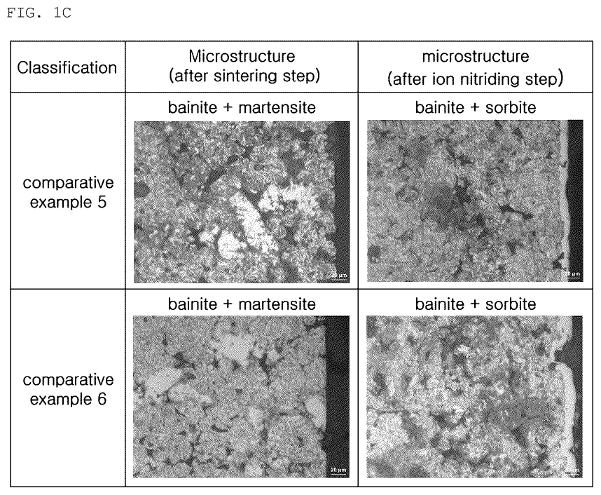

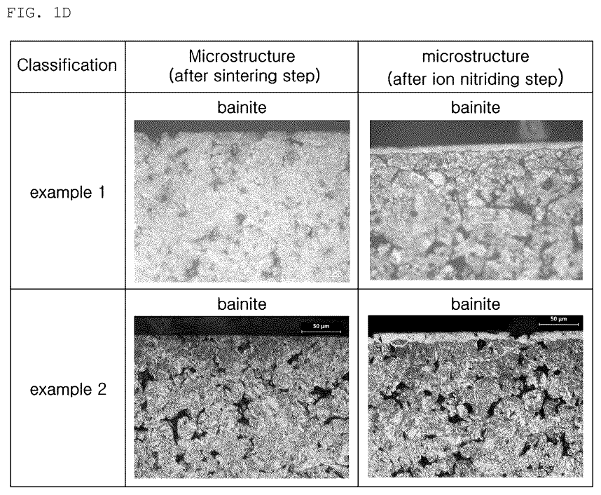

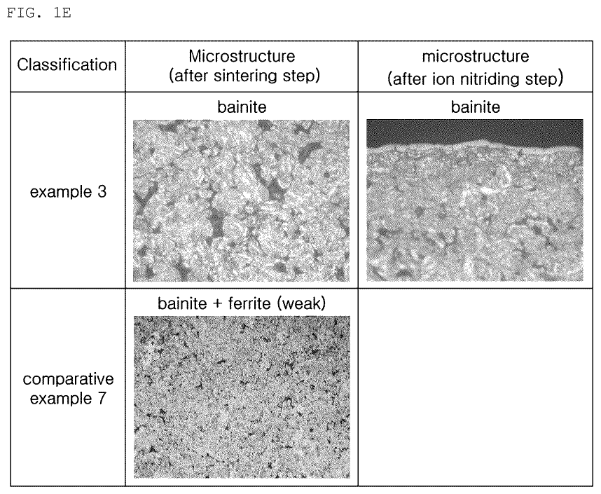

Further, the microstructure was identified after the sintering act and after the ion nitriding act, that is, before and after the ion nitriding act, and the surface hardness was measured, as necessary, and the results are shown in Table 2 and FIGS. 1A to 1E.

In this case, when the structure other than the bainite phase formed in excess of 0.6% per 200 mm², it is determined to be NG.

TABLE 1

| | | | | Relational |
|---|---|---|---|---|
| Classification | C | Cr | Mo | Equation 1 |
| Comparative Example 1 | 0.79 | 1.52 | 0.21 | 2.189 |
| Comparative Example 2 | 0.61 | 1.49 | 0.19 | 1.992 |
| Comparative Example 3 | 0.59 | 1.58 | 0.22 | 2.292 |
| Comparative Example 4 | 0.59 | 1.65 | 0.23 | 2.396 |
| Comparative Example 5 | 0.62 | 1.73 | 0.25 | 2.598 |
| Comparative Example 6 | 0.61 | 1.81 | 0.26 | 2.703 |
| Example 1 | 0.6 | 1.52 | 0.32 | 3.256 |
| Example 2 | 0.59 | 1.31 | 0.4 | 4.011 |
| Example 3 | 0.6 | 1.11 | 0.49 | 4.864 |
| Comparative Example 7 | 0.45 | 1.3 | 0.41 | 4.107 |

TABLE 2

| | Microstructure | Microstructure | |
|---|---|---|---|
| | (after | (after ion | |
| Classification | sintering act) | nitriding act) | REMARKS |
| Comparative | Perlite | Perlite | microstructure NG |
| Example 1 | | | Perlite portion: |
| Comparative | Bainite + | Bainite + | Hv500 or less |
| Example 2 | Perlite | Perlite | |
| | (weak) | (weak) | |
| Comparative | Bainite + | Bainite + | Microstructure |
| Example 3 | Martensite | Sorbite | NG |
| Comparative | Bainite + | Bainite + | Sorbite: Hv |
| Example 4 | Martensite | Sorbite | 300 to 400 |
| Comparative | Bainite + | Bainite + | levels |
| Example 5 | Martensite | Sorbite | |
| Comparative | Bainite + | Bainite + | |
| Example 6 | Martensite | Sorbite | |
| Example 1 | Full bainite | Full bainite | microstructure |
| | | | OK |
| Example 2 | Full bainite | Full bainite | microstructure |
| | | | OK |
| Example 3 | Full bainite | Full bainite | microstructure |
| | | | OK |
| Comparative | Bainite + | | microstructure |
| Example 7 | Ferrite | | |
| | (weak) | | NG |

As can be seen in Table 2 and FIGS. 1A to 1E, it can be confirmed that the types of microstructures in the Comparative Examples and Examples are determined depending on the content of the ingredients.

In particular, in Comparative Example 1, the content of carbon (C) was higher than the suggested content range and the content of molybdenum (Mo) was lower than the suggested content range, resulting in the formation of pearlite, which was determined to be NG in terms of microstructure. It was confirmed that the formed perlite as described above has a surface hardness of Hv 500 or less.

Further, in Comparative Example 2, the content of molybdenum (Mo) was lower than the suggested content range, resulting in the formation of pearlite with bainite. It was confirmed that the formed perlite as described above has a surface hardness of Hv 500 or less.

In case of Comparative Examples 3 to 6, the content of chromium (Cr) was higher than the suggested content range, which resulted in the formation of martensite with bainite after the sintering act. Accordingly, after the ion nitriding act, martensite was changed to sorbite and sorbite was formed with bainite. It was confirmed that the surface hardness is at the level of Hv 300 to 400 by the sorbite formed as described above.

In addition, in case of Comparative Example 7, the content of carbon (C) was lower than the suggested content range, resulting in the formation of ferrite with bainite after the sintering act, which was determined to be NG in terms of microstructure.

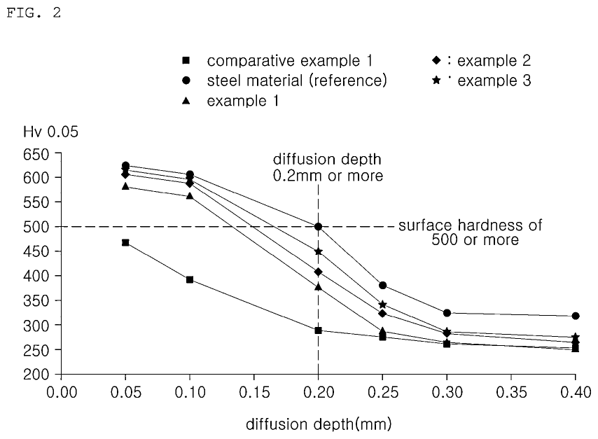

Next, to examine the properties after the ion nitriding act, the core hardness, tensile strength, and formation density were measured for Comparative Example 1 and Examples 1 to 3, and the results are shown in Table 3. In particular, the surface hardness according to the diffusion depth of nitrogen was measured for Comparative Example 1 and Examples 1 to 3 and is illustrated in FIG. 2.

TABLE 3

| | Comparative | | | |
|---|---|---|---|---|
| Classification | Example 1 | Example 1 | Example 2 | Example 3 |
| Core hardness | 85.6 | 76.1 | 77.3 | 77.1 |
| (HRB) | | | | |
| Tensile strength | 476 | 453 | 459 | 471 |
| (MPa) | | | | |
| Formation density | 6.89 | 6.92 | 6.9 | 6.93 |
| (g/cm²) | | | | |

As can be seen in Table 3 and FIG. 2, in case of Comparative Example 1, even though the core hardness, tensile strength, and formation density satisfied the conditions suggested by the present embodiment, it was confirmed that the surface hardness was less than Hv 500, which is significantly lower.

Meanwhile, in Examples 1 to 3, the core hardness, tensile strength, and formation density satisfied the conditions suggested by the present embodiment, and it was confirmed that the surface hardness was Hv 500 or more. In particular, in Examples 1 to 3, it was confirmed that the tensile strength was maintained similarly to that of the Comparative Example, while the core hardness was lower than that of Comparative Example 1. Accordingly, it can be expected that post-processing such as drilling may be easily performed.

While the present disclosure has been described with reference to the accompanying drawings and the aforementioned exemplary embodiments, but the present disclosure is not limited thereto but defined by the appended claims. Therefore, those skilled in the art can variously change and modify the present disclosure without departing from the technical spirit of the appended claims.

1. A prealloy powder for powder metallurgy used for manufacturing of a sintered part, the prealloy powder comprising:
1.05 to 1.55 wt % of Cr;
0.3 to 0.5 wt % of Mo; and
a remaining of Fe and impurities.

2. The prealloy powder of claim 1, wherein a content of the Cr and the Mo in the prealloy powder satisfies Equation 1:
$$0.1 \times [ Cr ] + 9.7 \times [ Mo ] > 3 \qquad [ Equation 1 ]$$
wherein [Cr] refers to a content of Cr (wt %) and [Mo] refers to a content of Mo (wt %).

3. The prealloy powder for powder metallurgy of claim 1, wherein the impurities comprise Si, Mn, P, S, Ni, Cu, or combinations thereof, and satisfy Equation 2:
$$[ Si ] + [ Mn ] + [ P ] + [ S ] + [ Ni ] + [ Cu ] < 0.5 \qquad [ Equation 2 ]$$
wherein [Si], [Mn], [P], [S], [Ni], and [Cu] refers a content (wt %) of Si, Mn, P, S, Ni, and Cu, respectively.

4. A sintered part manufactured by powder metallurgy, the sintered part comprising:
1.05 to 1.55 wt % of Cr;
0.3 to 0.5 wt %; of Mo;
0.5 to 0.7 wt % of C; and
a remaining of Fe and impurities.

5. The sintered part of claim 4, wherein a matrix structure of the sintered part is a bainite phase.

6. The sintered part of claim 5, wherein the sintered part has a microstructure further formed by the impurities, and
wherein an area of the microstructure is 0.6% or less per 200 mm².

7. The sintered part of claim 4, wherein the sintered part has a density in a range of 6.8 to 7.2 g/cmd.

8. The sintered part of claim 4, wherein a surface hardness of the sintered part is Hv 500 or more, and
wherein a diffusion depth of nitrogen is 0.2 mm or more from a surface of the sintered part.

9. The sintered part of claim 4, wherein the sintered part has a core hardness of HRB 75 or more.

10. The sintered part of claim 4, wherein the sintered part has a tensile strength of 430 MPa or more.

11. A method of manufacturing a sintered part by powder metallurgy, the method comprising:
preparing a prealloy powder comprising 1.05 to 1.55 wt % of Cr, 0.3 to 0.5 wt % of Mo, a remaining of Fe and impurities;
preparing a mixed powder by mixing the prepared prealloy powder with a carbon powder and a lubricant;
forming the prepared mixed powder to prepare a formed body;
sintering the prepared formed body;
post-processing a sintered part of the formed body sintered; and
ion nitriding the post-processed sintered part.

12. The method of claim 11, wherein the preparing of the prealloy powder comprises:
preparing a molten metal comprising 1.05 to 1.55 wt % of Cr, 0.3 to 0.5 wt % of Mo, and a remaining of Fe and impurities; and
water spraying the prepared molten metal.

13. The method of claim 11, wherein the preparing of the mixed powder comprises mixing 0.5 to 0.7 wt % of the carbon powder, 0.5 to 0.7 wt % of the lubricant, and the remaining of the prealloy powder.

14. The method of claim 13, wherein the preparing of the mixed powder further comprises mixing 0.1 to 0.2 wt % of a functional additive.

15. The method of claim 11, wherein the formed body comprises a formation density in a range of 6.8 to 7.2 g/cmd.

16. The method of claim 11, wherein, in the sintering, the sintered part has a bainite phase formed.

17. The method of claim 16, wherein the sintering is carried out in a mixed gas atmosphere of nitrogen and hydrogen at a temperature in a range of 1100 to 1150° C. for 20 to 40 minutes.

18. The method of claim 11, wherein the sintered part treated in the ion nitriding maintains a bainite phase.

19. The method of claim 18, wherein the sintered part treated in the ion nitriding has a compound layer formed 7 μm or more from a surface of the sintered part.

20. The method of claim 18, wherein the ion nitriding is carried out in a nitrogen gas atmosphere at a temperature in a range of 500 to 600° C. for 3 to 5 hours.
